(19) United States
(12) Patent Application Publication
(10) Pub. No.: US 2007/0239487 A1
(43) Pub. Date: Oct. 11, 2007

(54) Electronic health card and method of promoting the use of the electronic health card

(76) Inventors: Klaus Abraham-Fuchs, Erlangen (DE); Volker Wetekam, Marloffstein (DE); Sultan Haider, Erlangen (DE); Michael Mankopf, Mohrendorf (DE); Georg Heidenreich, Erlangen (DE)

Correspondence Address: BRINKS HOFER GILSON & LIONE, P.O. BOX 10395, CHICAGO, IL, 60610, US

(21) Appl. No.: 11/394,446

(22) Filed: Mar. 30, 2006

(51) Int. Cl. G06F 19/00; G06K 5/00

(52) U.S. Cl. 705/3; 235/380

(57) ABSTRACT

An electronic health card (EHC), system containing the EHC and a terminal, and method of promoting use of the EHC are provided. The EHC contains information that promotes the use of the EHC. This information may include personal information of the owner, authorization information that enables access to distributed sources of personal health records, and one or more health care benefits associated with the owner. The benefit may be selectable from individual incentives or predetermined bundles of incentives. The benefit may be conferred only if the owner uses the EHC when being provided with or when providing health care. Data communicated through contact or contactlessly between the EHC and terminal, and between the terminal and external databases, allows the owner to be provided with the benefit.

### TECHNICAL FIELD

The present embodiments relate to a electronic health card (EHC) and related method. More specifically, the present embodiments relate to an EHC, system containing the EHC and a terminal, and method of promoting use of the EHC.

### BACKGROUND

In several health care systems throughout the world, use of Electronic Health Cards (EHC) has just started or will start in the near future. Data can be accessed if doctors or dentists provide proof of their identity with a type of EHC called an electronic Health Professional Card (HPC) and the patient consents by entering a personal identification number (PIN).

The EHC typically contains information about the patient. Implementing the infrastructure for the EHC is costly for health care systems, but also offers a potential for cost savings. These savings may occur, e.g. through electronic transferal, electronic prescriptions, or avoidance of duplicated diagnostic procedures, which are all supported by the EHC.

Such potential benefits are directed to the health care professionals and health care institutions, and little monetary benefit goes directly to the patient. The patent may benefit in other ways, such as better recognition of dangerous interactions between different medications. Yet success of the EHC depends on broad usage. In certain situations, a physician cannot reject an ill patient and refuse treatment for ethical reasons, even when the patient does not present the card. Thus, there is no way to force the patient to carry and use the EHC.

Although the compliance of the patient can be the primary obstacle to successful broad use of the EHC, small physician practices may benefit only in the long run due to investments for the infrastructure (e.g. card reader, Software). These small physician practices may be reluctant to invest and participate in the EHC system. Additional incentives for Health Care Providers and medical professionals may be appropriate to increase the motivation to invest into and to use the EHC.

### BRIEF DESCRIPTION OF THE DRAWINGS

The present invention is illustrated by way of example and not limited to the accompanying figures in which like references indicate similar elements. Skilled artisans appreciate that elements in the figures are illustrated for simplicity and clarity and have not necessarily been drawn to scale. Exemplary embodiments will be explained in the following text with reference to the attached drawings, in which:

FIG. 1 shows a plan view of an EHC according to an embodiment.

FIG. 2 shows a sectional view of the EHC of FIG. 1.

FIG. 3 illustrates an embodiment of a system in which the EHC of FIG. 1 is used.

FIG. 4 is an embodiment of a flowchart of using the system of FIG. 3.

FIG. 5 shows a plan view of an EHC according to another embodiment.

### DETAILED DESCRIPTION

A method and apparatus are presented to increase usage of Electronic Health Cards (EHC) by patients and physicians who may otherwise not use the EHC system. To increase usage, various benefits and services are available and may be personalized to a patient who uses the EHC. Other benefits and services may be available to a physician who uses a HPC and the EHC system.

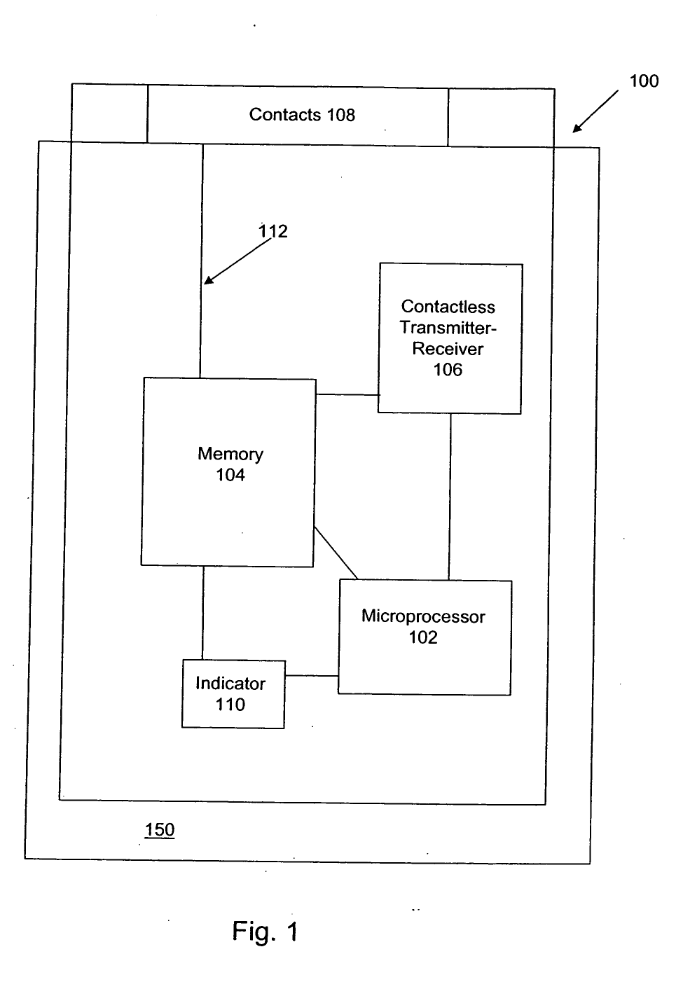

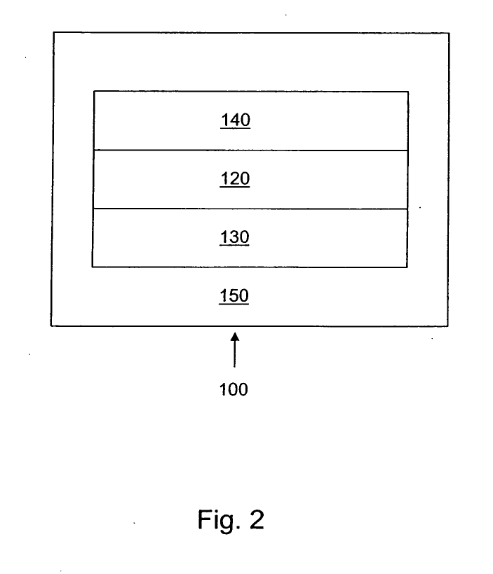

FIG. 1 shows a plan view of an electronic health card (EHC) 100. The EHC 100 in one embodiment contains a microprocessor 102, a memory 104, a contactless transmitter/receiver 106, contacts 108, and an indicator 110, as well as wiring 112 connecting the various components. Some of the components, such as the indicator 110 or the contactless transmitter/receiver 106 may not be present. The EHC 100 may be a single layer, or may contain multiple layers, as shown in FIG. 2. In the latter case, all or some of the above components may be provided on one or more of the layers 120, 130, 140, which may then be coated with a protective layer 150, which protects the components from the external environment. The thickness of the EHC 100 may be similar to or larger than the thickness of a conventional credit card. Stick, block or other shapes may be used instead of a card shape.

Each of the components may be implemented as separate circuits, or may be integrated into a single element. The microprocessor 102 can be any type of microprocessor suitable for controlling transmission of data into and from any of the components and/or providing desired functionality of the EHC 100. The memory 104 contains administrative information about the patient or physician. For example, the information contained in the memory 104 of the EHC can include personal identification, demographic data, medical insurance, emergency medical data, prescription information, medical history, test results, diagnoses, or authorization rights for health care providers. In addition, benefits available to the patient by using the EHC, such as those provided below, may be contained within the memory 104.

The contactless transmitter/receiver 106 and the contacts 108 provide mechanisms for the information in the memory 104 or other components to be provided to an external entity. The contactless transmitter/receiver 106 can contain either or both a transmitter and a receiver. The contactless transmitter/receiver 106 may transmit/receive radio-frequency (RF) signals or infrared (IR) signals to provide a communication link between the EHC 100 and the external entity to permit data to be provided from/to the external entity to/from the EHC 100.

The contacts 108 may be formed from the same material as the wiring 112, or may be formed from different material. The contacts 108 and/or the wiring 112 may contain layer(s) of one or more elements including, for example, Cu, Au, Ag, Pt, or Sn. If the EHC 100 has multiple layers, the wiring 112 and/or contacts 108 may be on the same layer or a different layer as the other components. The contacts 108 provide physical contact between the EHC 100 and the external entity to permit data to be provided from/to the external entity to/from the EHC 100. The contacts 108 are thus exposed and extend from the protective layer 150. The contacts 108 can be traces that are exposed as shown in FIG. 1 or can be housed in a terminal, which may be covered by the protective layer 150, so that only the edge of the terminal is exposed. Alternatively, the contacts 108 are recessed within the EHC 100, but accessible by plugging in a connector.

The indicator 110 may contain one or more indications of information in the memory 104 or processes occurring in the microprocessor 102, the contactless transmitter/receiver 106 or the contacts 108. The indicator 110 can include, for example, a display containing light-emitting diodes of the same or different colors. Different rates, colors, combinations or other variation may be used to indicate different processes.

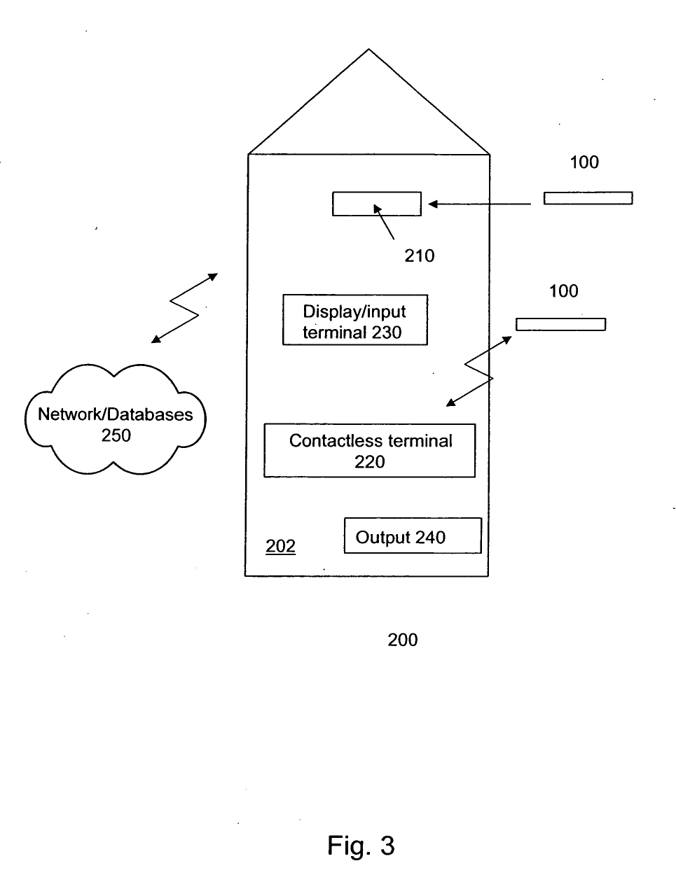

FIG. 3 illustrates an embodiment of a system 200 in which the EHC 100 is used. The system 200 includes the EHC 100 and an external entity 202, such as a kiosk. The EHC 100 is inserted into or brought in proximity to the kiosk 202. The kiosk 202 may contain a small housing 210, such as a card reader, into which the EHC 100 is inserted so as to make physical contact with the EHC 100. Alternatively, the kiosk 202 may be the small housing into which the EHC 100 is inserted, or the kiosk may be eliminated and an input device such as an electromagnetic scanner used. The kiosk 202 can contain a computer system having instructions that can be executed to cause the computer system to perform any method or desired computer-based function. The kiosk 202 may have a microprocessor and associated elements to control the various components in the kiosk 202 as well as circuitry that allows connectivity to other entities. A computer-readable medium may be present in one or more components of the kiosk 202 in which one or more sets of instructions, e.g. software, can be embedded. The instructions may reside partially or completely within the kiosk memory and/or the kiosk microprocessor during execution. Alternatively, dedicated hardware implementations, such as application specific integrated circuits, programmable logic arrays and other hardware devices, can be provided in the kiosk 202.

The kiosk 202 may be connected, for example through a local network or other network 250, to other computer systems, peripheral devices, or databases. Communications between the kiosk 202 and the network 250 may be implemented in accordance with any standard and protocol known in the art, for example, using the Internet or other packet switched network transmission (e.g., TCP/IP, UDP/IP, HTML, HTTP), WiFi, Bluetooth, etc.

In one embodiment, shown in FIG. 3, the kiosk 202 may contain a contactless terminal 220 that forms a communication link with the contactless transmitter/receiver 106 in the EHC 100. The kiosk 202 also contains a display 230 that may display information provided to and/or from the kiosk 202, such as patient information, physician information (e.g. contact information, location), benefit information. The display 230 may be, for example, a liquid crystal display (LCD), an organic light emitting diode (OLED), a flat panel display, a solid state display, or a cathode ray tube (CRT). The display 230 may be present locally in/on the kiosk 202, or may be connected through wires or a wireless network to a local display. The other components of the kiosk 202 may similarly be local to and/or remote from the kiosk 202. The display 230 may contain an input, such as a capacitive sensor or touch screen, to permit the user to navigate through various information. Alternatively, a separate keyboard or control device such as a mouse may be provided.

An output 240 may also be provided in the kiosk 202. The output 240 may provide physical material, such as a map to a particular physician or benefit information, and/or other feedback, such as an auditory feedback to indicate that connection to the EHC 100 has been established or terminated.

The kiosk 202 may be located in a physician's office, hospital, pharmacy, insurance office, or any other location in which information regarding the patient's medical information may be useful.

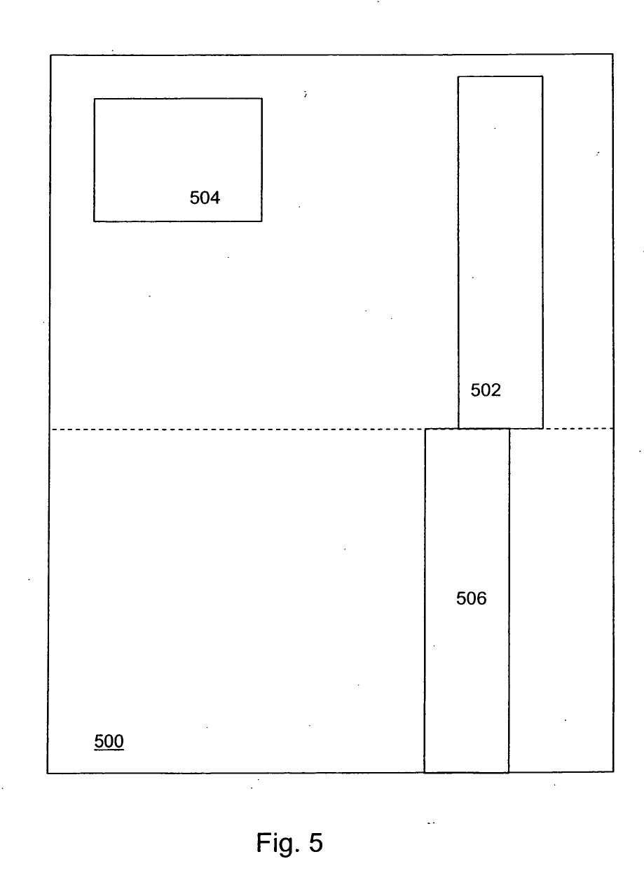

In other embodiments, such as shown in FIG. 5, the EHC 500 may be merely a card with particular identification information imprinted on it, e.g. using printed alphanumeric characters and/or stored electromagnetically. In the embodiment of FIG. 5, the EHC 500 is shown in a cutaway view of the top and bottom of the EHC 500. The alphanumeric characters are formed in a first region 502 on the top of the EHC 500 and may be raised or printed flat. An electromagnetic strip may be disposed on the bottom of the EHC 500 in a second region 506. The electromagnetic strip 506 may contain identification information and/or benefits information. Other identification 504 of the physician or patient, such as a photograph, fingerprint, retinal image and/or DNA sample may be provided on the EHC 500 in a third region 504. The card may be used in a manner similar to a credit card. Thus, rather than the EHC storing some or all information, the EHC may merely be used to provide access to personal/medical data of the patient or physician, which are stored at one or more central electronic storage facilities. Some or all of the data accessed may be displayed, printed, stored locally permanently or temporarily, or modified, for example. If the data is modified locally, it may be re-transmitted to the central location to overwrite the old data.

Providing incentives to the patient may be useful in convincing the patient to retain the card on their person. Similarly, due to costs of the EHC system, other incentives may be useful in convincing physicians to invest and participate in the EHC system. The incentives may overcome the cost of a physician purchasing the equipment used in the EHC system.

Such incentives may be selectable by the patient or predetermined, and may be individual incentives or bundled into packages of incentives. The incentives may be dependent on, e.g., the patient, the health care provider, health insurance institution, government agency, time of initial activation or present usage of the EHC. A patient may only have access to the incentives when he or she carries and uses the EHC. The authorization and identification information contained on the EHC is used to unlock and/or activate data, information and services from which the patient can benefit and in which he or she has an interest. Additional service-specific personal identification numbers and passwords may be stored on the EHC, which permit new offerings to be accessible to the patient only when he or she carries his EHC with him. Alternatively, data is communicated from the kiosk 202 or EHC to another location to provide one or more benefits or incentives provided in response to use of the EHC.

The EHC may store personal information of the patient. This personal information may include age, gender, education, allergies, demographic data, medical insurance data, emergency medical data, prescription information, or authorization rights to Electronic Health Records. Such information can be used to tailor information and services specifically to the user. The authorization and identification data stored on the card may enable access to distributed sources of personal health records. The health record data then can be used to enhance and improve the offered information and services to the particular patient. For example, discounts on drugs frequently prescribed for a particular patient are offered for use the EHC.

Besides providing discounts for prescriptions or physician services, other specialized services may be offered. For example, one such service may be to translate a physician's transferal letter (possibly stored on the EHC) such that it is better understood by the patient by tailoring the wording to the patient's personal and medical background. In this case, data on the EHC and/or additional data accessible through the authorization mechanism on the EHC may be used to prepare the translated referral letter.

Another service may be used to create a personalized electronic information leaflet for a prescribed medication. For example, the information on the medicament can be better understandable to the patient by cutting it down to what is relevant for the patient and tailoring the wording to the patient's background. For example, the information provided to a patient who is a physician may be more complex than the information provided to a patient who is less knowledgeable. As above, data on the EHC card and/or additional data accessible through the authorization mechanism on the EHC may be used to prepare the personalized electronic information leaflet. This service can be offered in connection with each electronic prescription, test or diagnosis stored on the card through a card reader terminal in the pharmacy where the prescribed medication is bought or other medical facility. Both of these services permit potentially complicated instructions and directions regarding a patient to be simplified as desired.

Another service that may be used to provide particularized data for a patient may be that of an optimized diet for weight loss or other health issues. This diet may be optimized with respect to the medical history of the patient in which the medical history data are accessible through the EHC. This permits tailoring of the diet to the individual needs of the patient and, if the diet is stored on the EHC, allows this diet to be viewed and modified as desired.

The EHC may permit remote or automatic scheduling for physician appointments. This may include automatic reminders of appointments sent to a location or device. For example, a user may schedule a periodic checkup and have a reminder sent to an email account, a text message, or automatic phone call when the time for the appointment is within a predetermined period or when a related EMC usage occurs. Bluetooth or other wireless protocol or a connector may be used to communicate the request for an appointment to a telephone or home computer, and then to a physician.

The EHC may additionally permit access rights to services which offer background information on diseases or support in chronic disease management. Such services may be certified by an official public health care institution, such as a health care agency or ministry, a public or private health care institution, or a public or private health insurance institution.

Similar mechanisms can be used to offer valuable information, data banks or services to the health care provider or medical professional for motivating him or her to use the HPC. The authorization and identification mechanisms for access stored on the HPC may be used to give the health professional access to services such as remote courses/facilities, discounts on medical equipment, or shortened time periods to receive payments from government agencies for services rendered to patients.

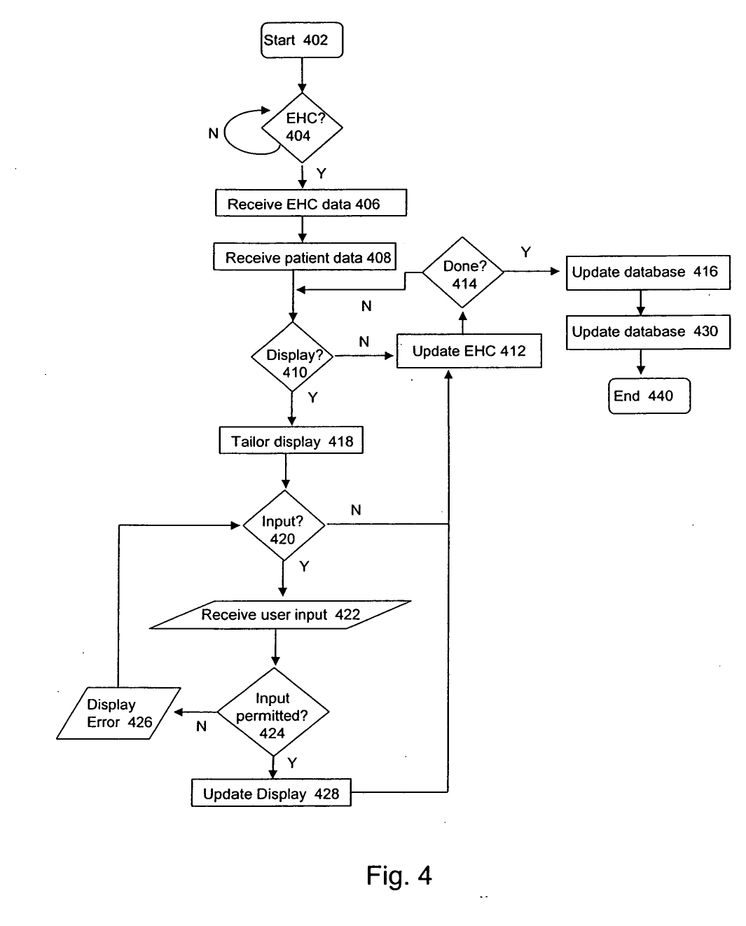

FIG. 4 illustrates a flowchart of an embodiment of the system 200 of FIG. 3. Block 402 indicates the start of the flowchart. The kiosk 202 or other entity waits until sensing the presence of the EHC 100, either remotely or when the EHC 100 is inserted into the housing 210, in block 404. During this time, the kiosk 202 can be in communication with the network (not shown) and various remote databases and may continuously poll for the EHC 100 or be triggered. If the presence of the EHC 100 is detected, data is transferred from the EHC 100 to the kiosk 202 in block 406. The kiosk 202 then receives data regarding the patient from the databases on the network 250 in block 408 or the EHC 100. If the kiosk 202 does not contain a display 230 in block 410, then the EHC 100 can be updated with additional patient information, e.g. benefits available, benefits received, adjusted or different medicines or dosages, medical refills available, new diet plan, test results, diagnoses or other information in block 412. Such updating may include rewriting some or all of a magnetic strip on the EHC 100 or updating a memory of the EHC 100. If the updating of the EHC 100 is completed in block 414, any databases to be updated are updated in block 416 before the interaction is completed in block 440. If the updating of the EHC 100 is not completed in block 414, and further interaction is to be performed, whether a display 230 is present may again be determined in block 410. Alternatively, the updating of the EHC 100 and the databases may be switched.

If the kiosk 202 contains a display 230, then one screen or a series of screens can be displayed, if desired. The screens can be personalized to the particular patient, standard screens independent of the patient, or a combination of both in block 418. If an input device is not present or is present but an input is not sensed in a predetermined amount of time, a particular screen can be displayed on the display 230 requesting continuation of the interaction, or the interaction can be automatically terminated and the EHC 100 updated in block 412, as above. If an input device is present and an input is provided in block 420, the input is received in block 422. The validity of the input received may be tested in block 424. If the input is invalid, an error message may be shown on the display 230 in block 426 and the system may wait until another input is sensed. If the input is valid, the display 230 may be updated and new information displayed in block 428. The input can be the selection of a particular key on a keypad, a location on a touch screen, or mouse input, for example. The selection can be, for example, guidance to a particular screen or updating of patient or doctor information on the EHC.

The benefit(s) associated with the particular patient or physician may be automatically provided after a predetermined event occurs, such as when a specific set of data is transferred between the EHC and the kiosk. Alternatively, the benefits may be provided only after a trigger is provided from an external entity, such as a governmental agency, a health care institution, or a health insurance institution. If, for example, a patient visits a physician and uses their EHC, either or both the patient and the physician (or other entity, such as a pharmacy or hospital in which the kiosk is located) may receive a benefit after the initial transfer of data from the EHC to the kiosk, after the patient has entered a predetermined input on the kiosk, the patient and/or physician has completed a predetermined set of tasks, or either or both the EHC and databases are updated. In FIG. 4, the benefit is transferred to at least one of the recipients after the EHC and databases are updated in block 430. The benefit may be communicated to the recipients immediately, e.g. electronically through the kiosk display, kiosk output, or output to the recipient's desired electronic device, or may be communicated at a later date. In the latter case, a letter may be sent from the governmental agency or location where the kiosk is located after the information is downloaded (which may occur periodically). Alternatively, the communication may be provided by the kiosk or electronic device the next time the patient uses the EHC.

Of course, in any embodiment, as the information contained or elicited by the EHC may be highly personal, known electronic security measures may be taken to secure the information during usage and transmission. Such security measures may include passwords for accessing information on the EHC and/or databases as well as various security protocols for transmission and reception of information between the EHC, the databases, and the kiosk. Finger print or other personal identification devices may be used.

Although the EHC is described as one embodiment of a personalized access and authorization medium to health care data and health care networks, other technical solutions for carrying such information are possible. Similar information may be stored in various well-accepted portable electronic devices or technologies yet to find wide acceptance. For example, instead of a dedicated EHC, the EHC may be data stored in the memory of a cell phone memory, personal data assistant, laptop computer, electronic passport, or other electronic device having the capability to store the information. The data may be stored in a RF ID tag implanted in the patient. The health care networks may be part of a private health care system or may be established as part of a public governmental health care system.

It is therefore intended that the foregoing detailed description be regarded as illustrative rather than limiting, and that it be understood that it is the following claims, including all equivalents, that are intended to define the spirit and scope of this invention. Nor is anything in the foregoing description intended to disavow scope of the invention as claimed or any equivalents thereof.

We claim:

1. An electronic health card (EHC) comprising identification of an owner of the EHC and a health care benefit associated with the owner of the EHC and provided by at least one of a governmental agency, a health care institution, or a health insurance institution.

2. The EHC of claim 1, wherein the owner is a patient and the benefit comprises access to at least one of:
a discount for at least one of a prescription or a physician service;
translation of a physician's transferal letter by at least tailoring of wording of the transferal letter to personal and medical background of the patient;
creation of a personalized electronic information leaflet for a prescribed medication;
an optimized diet with respect to individual needs of the patient;
remote or automatic scheduling for physician appointments; or
services which offer background information on diseases or support in chronic disease management.

3. The EHC of claim 1, wherein the owner is a physician and the benefit comprises access to at least one of remote courses or facilities, discounts on medical equipment, or shortened time periods to receive payments from at least one of the governmental agency or health insurance institution for services rendered to patients.

4. The EHC of claim 1, wherein the owner is a patient and the EHC further comprises authorization information, the authorization and identification information enables access to distributed sources of personal health records of the patient.

5. The EHC of claim 1, wherein the owner is a patient, the EHC further comprises personal information of the patient, and the personal information includes age, gender, education, and allergies of the patient.

6. The EHC of claim 1, wherein the benefit comprises an individual incentive selectable from one or more incentives in a group of incentives or comprises a bundle of incentives selectable from different predetermined bundles of incentives.

7. The EHC of claim 1, wherein the EHC further comprises at least one of a service-specific personal identification number or password stored on the EHC.

8. The EHC of claim 1, wherein the EHC further comprises a memory that stores the identification and the health care benefit and a microprocessor that communicates with the memory.

9. The EHC of claim 1, wherein the EHC further comprises at least one of a contactless transmitter or receiver.

10. An electronic health card (EHC) system comprising:
a portable data device containing identification of an owner of the portable data device and a health care benefit associated with the owner of the portable data device and provided by at least one of a governmental agency, a health care institution, or a health insurance institution; and
a terminal, the portable data device and terminal adapted to transfer data therebetween.

11. The EHC system of claim 10, wherein the terminal is in communication with a health care network.

12. The EHC system of claim 10, wherein the terminal is disposed in a least one of a pharmacy, hospital or an office of at least one of a physician, insurance agency, or governmental health care agency.

13. The EHC system of claim 10, wherein the owner is a patient and the benefit comprises access to at least one of:
a discount for at least one of a prescription or a physician service;
translation of a physician's transferal letter by at least tailoring of wording of the transferal letter to personal and medical background of the patient;
creation of a personalized electronic information leaflet for a prescribed medication;
an optimized diet with respect to individual needs of the patient;
remote or automatic scheduling for physician appointments; or
services which offer background information on diseases or support in chronic disease management.

14. The EHC system of claim 10, wherein the owner is a physician and the benefit comprises access to at least one of remote courses or facilities, discounts on medical equipment, or shortened time periods to receive payments from at least one of the governmental agency or health insurance institution for services rendered to patients.

15. The EHC system of claim 10, wherein the owner is a patient and the portable data device further comprises authorization information, the authorization and identification information enables access to distributed sources of personal health records of the patient.

16. The EHC system of claim 10, wherein the owner is a patient, the portable data device further comprises personal information of the patient, and the personal information includes age, gender, education, and allergies of the patient.

17. The EHC system of claim 10, wherein the benefit comprises an individual incentive selectable from one or more incentives in a group of incentives or comprises a bundle of incentives selectable from different predetermined bundles of incentives.

18. The EHC system of claim 10, wherein the EHC further comprises at least one of a service-specific personal identification number or password stored on the portable data device.

19. The EHC system of claim 10, wherein the portable data device further comprises at least one of a first contactless transmitter or receiver, the terminal comprises at least one of a second contactless transmitter or receiver, and the at least one of the first contactless transmitter or receiver is adapted to communicate with the at least one of the second contactless transmitter or receiver.

20. The EHC system of claim 10, wherein the terminal comprises at least one of a display adapted to display information provided to the terminal from at least one of the portable data device, a database in communication with the terminal, or a memory in the terminal, an input device adapted to receive input data from the owner, or an output adapted to provide physical material to the owner.

21. The EHC system of claim 10, wherein the portable data device comprises an EHC.

22. A method of promoting use of electronic health cards (EHCs), the method comprising:
providing a plurality of EHCs, each EHC containing identification of an owner;
establishing a health care benefit associated with the owner of the EHC; and
providing the health care benefit only if the owner of the EHC uses the EHC when being provided with or when providing health care.

23. The method of claim 22, wherein establishing the benefit comprises permitting access to at least one of:
a discount for at least one of a prescription or a physician service;
translation of a physician's transferal letter by at least tailoring of wording of the transferal letter to personal and medical background of the owner;
creation of a personalized electronic information leaflet for a prescribed medication;
an optimized diet with respect to individual needs of the owner;
remote or automatic scheduling for physician appointments; or
services which offer background information on diseases or support in chronic disease management.

24. The method of claim 22, wherein establishing the benefit comprises permitting access to at least one of remote courses or facilities, discounts on medical equipment, or shortened time periods to receive payments from at least one of a governmental agency or health insurance institution for services rendered to patients.

25. The method of claim 22, further comprising enabling access to distributed sources of personal health records of the owner using authorization information of the EHC.

26. The method of claim 22, further comprising storing personal information of the owner on the EHC, the personal information including age, gender, education, and allergies.

27. The method of claim 22, wherein providing the health care benefit comprises at least one of permitting selection of an individual incentive from one or more incentives in a group of incentives or permitting selection of a bundle of incentives from different predetermined bundles of incentives.

28. The method of claim 22, further comprising storing at least one of a service-specific personal identification number or password on the EHC.

29. The method of claim 22, further comprising updating at least one of the EHC and a database external to and associated with the EHC after the owner has been provided with the health care.

30. The method of claim 22, further comprising communicating with a database external to and associated with the EHC before the owner has been provided with the health care using authorization and identification information contained on the EHC.
